(19) United States
(12) Patent Application Publication
(10) Pub. No.: US 2006/0044125 A1
(43) Pub. Date: Mar. 2, 2006

(54) Device for detecting the position of a vehicle wheel

(75) Inventor: Michel Pierbon, Pibrac (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TULOUSE CEDEX 1 (FR)

(21) Appl. No.: 10/529,389

(22) PCT Filed: Nov. 17, 2003
(86) PCT No.: PCT/EP03/12805

§ 371 Date: Mar. 28, 2005

(30) Foreign Application Priority Data
Nov. 22, 2002 (FR) 02/14632

(51) Int. Cl. B60C 23/02; G08B 21/00; B60C 23/00

(52) U.S. Cl. 340/442; 340/671; 340/686.1

(57) ABSTRACT

The invention relates to a device for detecting the position of a vehicle wheel (2), which is intended, in particular, for a vehicle equipped with a tyre pressure monitoring system. The inventive device consists of first and second means of measuring acceleration in a direction (D1, D2) comprising a component in a vertical plane. The vertical plane components of the measuring directions of the first and second measuring means present an angular offset (α) other than 0° or 180°.

The present invention relates to a device for detecting the position of a wheel on a vehicle. Such a device is intended in particular to be used in a system for monitoring the pressure of the tires on a motor vehicle.

Some motor vehicles are now equipped with a device allowing the driver to monitor the pressure of his tires so as in particular to detect a puncture. Each wheel on such a vehicle is then equipped with a pressure sensor placed inside the tire. Associated with each sensor is a transmitter for sending the pressure measurements made to a control and management device mounted in the vehicle. When information is sent to the central processing unit, it is necessary to know from which sensor it comes so that, should there be a problem, the driver can be informed about the wheel in which the problem has arisen.

One way of locating the wheels consists in determining, on the one hand, whether the signal is received from a right wheel or a left wheel and, on the other hand, in determining whether the signal is coming from a front wheel or a rear wheel.

The present invention relates to the problem of right/left location of a wheel on a vehicle. Document EP-0 760 299 proposes to solve this problem by employing a sensor consisting of a rolling commutater. A ball placed inside this rolling commutater allows the direction of rotation of an associated wheel to be determined. Knowing whether the vehicle is moving forward or rearward, it is therefore possible to determine whether the wheel is a right wheel or a left wheel on the vehicle.

This partially mechanical device may seize up. Furthermore, above a relatively low speed the ball is pressed by the centrifugal force against the wall of the rolling commutater and no longer moves, therefore no longer providing any indication. The direction of rotation must therefore be measured within the first few seconds of the vehicle moving.

The object of the present invention is to provide a novel device for determining the right/left location of a wheel in a self-contained manner, that is to say without it being necessary to exchange information with the vehicle in order to determine the position of the wheel.

For this purpose, the invention proposes a device for detecting the position of a wheel on a vehicle, especially a vehicle equipped with a system for monitoring the pressure of its tires.

According to the invention, this detection device comprises first and second means capable of measuring an acceleration in a direction having a component in a vertical plane and the components in the vertical plane of the measurement directions of the first and second measurement means have an angular offset different from 0° and from 180°.

When the wheel with which these means capable of measuring an acceleration are associated rotates, these means, which are called hereafter accelerometers for the sake of simplification, measure, in the vertical plane, an acceleration having, on the one hand, a continuous component, corresponding to the centripetal acceleration generated by the rotation of the wheel, and, on the other hand, a variable component, corresponding to the Earth's attraction. Since the measurement directions of the accelerometers are angularly offset in the vertical plane, a phase shift will appear in the variable component (that varies sinusoidally) of the measurements made by the accelerometers. It is possible to determine the direction of rotation of the associated wheel according to the measured phase shift, which in absolute value corresponds to the angular offset between the measurement directions. If the direction of movement of the vehicle is then known, it is possible to determine whether the wheel associated with the accelerometers is on the right or on the left of the vehicle.

The measurement directions of the first and second measurement means preferably both lie in a vertical plane. In this way, the signals measured by the accelerometers are not attenuated and serve entirely for determining the position of the wheel.

For optimum exploitation of the signals delivered by the accelerometers, the angular offset in the vertical plane of the first and second measurement directions is between 30° and 150°. Thus, phase shifts too close to 0° (or 180°) are avoided.

The first and second means capable of measuring an acceleration are, for example, shock sensors. Such a sensor is generally a transducer that incorporates an element made of a piezoelectric ceramic placed in a rigid case. The acceleration undergone by the sensor acts on the piezoelectric element in order to deliver an electrical signal. Electrodes placed at the ends of the piezoelectric element then allow the potential difference that appears between them to be measured.

In a preferred embodiment, the first and second means capable of measuring an acceleration are placed on the same support.

The present invention also relates to a pressure sensor of a tire pressure monitoring system, comprising an integrated circuit board supporting various electronic components for measuring pressure and for sending information via electromagnetic waves. According to the invention, this sensor furthermore includes a position detector as described above.

Advantageously, the first and second means capable of measuring an acceleration of the detection device are mounted on the printed circuit board of the sensor. The detection device according to the invention is then fully integrated into the sensor and into the tire pressure monitoring system. The information relating to the location of the wheel may thus be transmitted directly to the pressure sensor.

The present invention also proposes a method of detecting the right/left position of a wheel on a vehicle. This method comprises the following steps:
measurement of a first acceleration and a second acceleration, each in a direction having a component in a vertical plane, the components in the vertical plane of the directions having an angular offset;
calculation of the phase shift between the signals corresponding to the two accelerations measured;
determination of the direction of rotation of the wheel according to the phase shift; and
determination of the position of the wheel relative to the vehicle, the direction of movement of the vehicle being determined elsewhere.

As indicated above in the case of the detection device, the measurement directions preferably lie in a vertical plane.

In an advantageous implementation, allowing right/left location without any external information, the measurements are taken only when the vehicle is running at a predetermined minimum speed, it being assumed that the vehicle is moving forward. Since the speed of the vehicle is proportional to the centripetal acceleration undergone by the detection device according to the invention, this device can estimate the speed of the vehicle in order to thus determine the moment when it can locate the wheel.

The details and advantages of the invention will become apparent from the description that follows, given with reference to the appended schematic drawing in which:

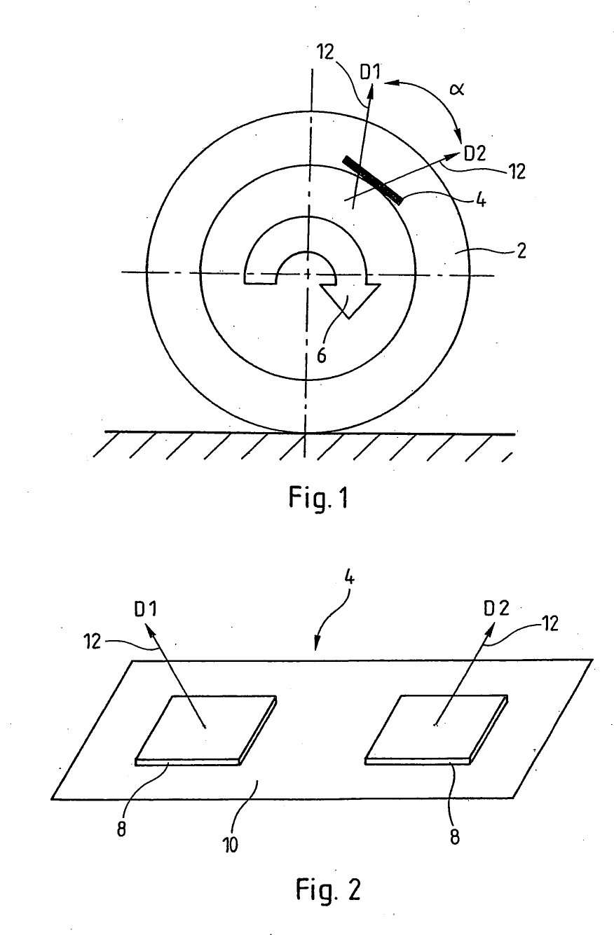

FIG. 1 shows schematically a right/left position detection device placed on a wheel; and

FIG. 2 shows very schematically, in perspective, a pressure sensor equipped with a device according to the invention.

FIG. 1 shows very schematically a right wheel 2 of a vehicle equipped with a detection device 4 according to the present invention. The wheel 2 and the detection device 4 have not been drawn to scale. It is assumed that this wheel 2 rotates in the direction indicated by the arrow 6 and that the corresponding vehicle is moving forward.

The wheel 2 is a conventional right wheel on a vehicle. The latter is equipped with a tire pressure monitoring system. This wheel 2 therefore also includes a pressure sensor associated with the detection device 4.

The detection device 4 comprises two accelerometers 8 that are mounted so as to be parallel to each other on a support 10. The latter is, for example, the printed circuit board (PCB) of the pressure sensor placed in the tire associated with the wheel 2. This printed circuit supports the pressure sensor and the electronics associated therewith. Such a pressure sensor is known to those skilled in the art and does not need to be described in further detail for the present invention.

Each accelerometer 8 is, for example, a shock sensor that has two electrodes and delivers a potential difference across its electrodes that is proportional to the acceleration undergone by the sensor. It is possible to use here a shock sensor such as those already used in the automobile industry for the triggering of airbags. Mention may be made here, for example, of a shock sensor sold by the company muRata under the brand name PIEZOTITE and bearing the reference PKGS-00RA. Such a sensor is used for triggering airbags and must therefore, for obvious safety reasons, meet very stringent standards. In this case, it is possible to use sensors of the same type, but of a lower cost given that the requirements in terms of safety are much lower in the present application than in an airbag.

Such an accelerometer is, for example, in the form of a parallelepiped. The shock sensor, the reference of which was mentioned above, has a thickness of about 1.5 mm, a width of about 2.8 mm for a length of about 6.4 mm. These accelerometers 8 are placed flat on their support 10 and are oriented parallel to each other. However, these accelerometers are chosen in such a way that they each measure the acceleration undergone by the support 10 in different directions that make an angle different from 0° and 180° between them. These directions are preferably chosen so as to lie in a vertical plane of the position of the wheel 2. The acceleration measurement directions are indicated in FIG. 1 by arrows 12. Each of these arrows indicates the measurement direction of an accelerometer 8. These two directions make an angle α between them. In the case shown in the drawing, this angle α is about 60°. This angle may take values within a relatively large range. It is preferred to choose values neither too close to 0° nor to close to 180°. Preferably, α will take a value between 30° and 150°.

The acceleration measured by each accelerometer 8 has two components. A continuous first component is due to the centripetal force while the variable second component is due to the Earth's attraction. The continuous first component is proportional to the speed of rotation of the wheel 2 and therefore to the speed of the vehicle. The second component varies sinusoidally. In fact, depending on the position of the accelerometer 8 with respect to the wheel, this accelerometer experiences an acceleration that varies between −1 G (=9.81 m/s²) and 1 G. Only the vertical component is used to detect the direction of rotation of the wheel 2.

Location of the wheel is carried out when moving forward. It is therefore possible, for example, for it to be detected only when the vehicle has reached a predetermined speed, for example 40 or 50 km/h. It will therefore be assumed, which seems reasonable, that the vehicle is not moving in reverse at such a speed. It is also possible to detect differently whether the vehicle is moving forward or backward. In the case of a vehicle equipped with an automatic gearbox, the position of the gear selector is used to deliver the information. In another type of vehicle, a contactor is generally provided for detecting the selection of reverse gear and for turning on the reversing lights. This contactor may therefore also be used to determine whether the vehicle is moving forward or backward.

The signals output by the two accelerometers 8 are phase-shifted, in absolute value, by the angle α. The direction of rotation of the wheel is detected by analyzing the phase shift between the signals output by each of the accelerometers. If the variable component of the signal corresponding to the direction D1 (cf. FIG. 1) is delayed relative to the variable component of the signal output by the accelerometer corresponding to the direction D2, then the wheel is rotating in the direction of the arrow 6. If the vehicle is moving forward, this means that the wheel 2 is a right wheel. In the opposite case (component corresponding to D1 leading with respect to D2), the vehicle still moving forward, the wheel would be a left wheel.

To summarize, in one embodiment according to the invention, the right/left position of a wheel 2 on the vehicle is detected above a minimum speed for which it is assumed that the vehicle is moving forward. The wheels mounted on the left of this vehicle rotate in the opposite direction to those mounted on the right side. The detection device 4 according to the invention therefore allows the direction of rotation of each wheel to be determined. Since the information relating to the positioning (right/left) of the wheel is available within each wheel, this information may be transmitted to the vehicle, or more precisely to the module for managing the tire pressure monitoring system, at the same time that the information relating to the pressure measurements made are sent.

A tire pressure sensor incorporating a detection device according to the invention is mounted inside the tire of a wheel and itself indicates, autonomously, whether it is in a wheel mounted on the left or on the right of the vehicle. This information may be transmitted by radio waves. This communication channel is already used for transmitting the pressure inside the tire. Thus, location of the wheel is possible without an element external to the latter.

The present invention is not limited to the preferred embodiment described above by way of non-limiting examples, or to the variants suggested. It also relates to all variants within the competence of a person skilled in the art in the context of the claims appended hereto.

Thus, for example, the wheels on a vehicle may be located at any moment and not merely when the vehicle has reached a minimum speed. As already indicated, the accelerometers may be different from the reference mentioned—all that is required is to have a sensor for measuring an acceleration in a given direction.

To make it easier to use the signal delivered by the accelerometers, the acceleration measurement directions of the latter preferably lie in a vertical plane. However, all that is required is for each accelerometer to measure the acceleration in a direction having a vertical component.

1. A device for detecting the position of a wheel (2) on a vehicle, especially a vehicle equipped with a system for monitoring the pressure of its tires, characterized in that it comprises first and second means (8) capable of measuring an acceleration in a direction (D1, D2) having a component in a vertical plane and in that the components in the vertical plane of the measurement directions of the first and second measurement means have an angular offset (α) different from 0° and from 1800.

2. The detection device as claimed in claim 1, characterized in that the measurement directions (D1, D2) of the first and second measurement means both lie in a vertical plane.

3. The detection device as claimed in claim 1, characterized in that the angular offset (α) in the vertical plane of the first and second measurement directions (D1, D2) is between 30° and 150°.

4. The detection device as claimed in claim 1, characterized in that the first and second means capable of measuring an acceleration are shock sensors (8).

5. The detection device as claimed in claim 1, characterized in that the first and second means capable of measuring an acceleration are placed on the same support (10).

6. A pressure sensor of a tire pressure monitoring system, comprising an integrated circuit board (10) supporting various electronic components for measuring pressure and for sending information via electromagnetic waves, characterized in that it furthermore includes a position detector (4) as claimed in claim 1.

7. The pressure sensor as claimed in claim 6, characterized in that the first and second means (8) capable of measuring an acceleration of the detection device are mounted on the printed circuit board (10) of the sensor.

8. A method of detecting the right/left position of a wheel on a vehicle, characterized in that it comprises the following steps:
measurement of a first acceleration and a second acceleration, each in a direction having a component in a vertical plane, the components in the vertical plane of the directions having an angular offset;
calculation of the phase shift between the signals corresponding to the two accelerations measured;
determination of the direction of rotation of the wheel according to the phase shift; and
determination of the position of the wheel relative to the vehicle, the direction of movement of the vehicle being determined elsewhere.

9. The detection method as claimed in claim 8, characterized in that the measurement directions lie in a vertical plane.

10. The detection method as claimed in claim 8, characterized in that the measurements are taken only when the vehicle is running at a predetermined minimum speed, it being assumed that the vehicle is moving forward.

11. The detection device as claimed in claim 2, characterized in that the angular offset (α) in the vertical plane of the first and second measurement directions (D1, D2) is between 30° and 150°.

12. The detection device as claimed in claim 2, characterized in that the first and second means capable of measuring an acceleration are shock sensors (8).

13. The detection device as claimed in claim 3, characterized in that the first and second means capable of measuring an acceleration are shock sensors (8).

14. The detection device as claimed in claim 2, characterized in that the first and second means capable of measuring an acceleration are placed on the same support (10).

15. The detection device as claimed in claim 3, characterized in that the first and second means capable of measuring an acceleration are placed on the same support (10).

16. The detection device as claimed in claim 4, characterized in that the first and second means capable of measuring an acceleration are placed on the same support (10).

17. The detection method as claimed in claim 9, characterized in that the measurements are taken only when the vehicle is running at a predetermined minimum speed, it being assumed that the vehicle is moving forward.
